(19) United States
(12) Patent Application Publication
(10) Pub. No.: US 2016/0239640 A1
(43) Pub. Date: Aug. 18, 2016

(54) SYSTEMS, METHODS AND MEDIA FOR COMPUTATIONALLY DETERMINING CHEMICAL PROPERTIES OF A MOLECULE

(71) Applicant: Colorado School of Mines, Golden, CO (US)

(72) Inventors: Mark E. Eberhart, Denver, CO (US); Travis E. Jones, Golden, CO (US)

(21) Appl. No.: 15/012,511

(22) Filed: Feb. 1, 2016

Related U.S. Application Data
(63) Continuation of application No. 12/404,940, filed on Mar. 16, 2009, now abandoned.
(60) Provisional application No. 61/036,777, filed on Mar. 14, 2008.

(51) Int. Cl. G06F 19/00

(52) U.S. Cl. CPC G06F 19/701; G06F 19/704

(57) ABSTRACT

Methods of identifying irreducible bundles and bond bundles of open systems (such as molecules) are described. Methods of determining chemical properties of the molecules, computer systems and computer readable media are also provided.

This application is a continuation of U.S. patent application Ser. No. 12/404,940, entitled “Systems, Methods and Media for Computationally Determining Chemical Properties of a Molecule,” and filed Mar. 16, 2009, which claims the benefit of priority under 35 USC §119(e) to U.S. Patent Application 61/036,777, entitled “Systems, Methods and Media for Computationally Determining Chemical Properties of a Molecule” and filed Mar. 14, 2008, the disclosure of which is incorporated by reference herein in its entirety.

### FEDERALLY SPONSORED RESEARCH

This application was supported, at least in part, by Grant No. ONR FRS 442553 and DARPA FRS 442658. The U.S. Government may have certain rights in the invention.

### FIELD

The disclosure generally relates to methods, computer systems, and computer readable media used to model chemical structures and to determine their chemical properties and their partitioning into contributions from individual bonds.

### BACKGROUND

The field of molecular design is concerned with the ability to manipulate the chemical and physical properties of molecules and solids. This is achieved by first measuring or calculating the properties of a molecule or solid and then determining how these properties are partitioned among the molecule's atoms and bonds. Often a property is due to a small subset of the molecule's atoms and bonds, in which case this group is called a functional group. Design is achieved through the systematic variation of functional groups to produce optimum properties. Hence, the ability to partition molecules into their functional regions is an essential and enabling component of molecular design.

The chemical and physical properties of molecules can be determined either through direct measurement or through calculations. And there are many computational techniques available to perform these calculations. However, when it comes to partitioning the molecule into its functional regions there are only a few methods. The most widely used and accepted methodology is a topological approach articulated by Bader, R. F. W., Atoms in Molecules: A Quantum Theory, Clarendon Press: Oxford, U K, 1990. Bader constructed a partitioning that allows one to identify the boundaries between the atoms within a molecule. The properties of these topological atoms are well-defined and additive to give the corresponding values of the molecular properties. For example, the energy of atomic regions can be summed to give the molecular energy. Other properties of the atoms can also be determined and the contributions of individual atoms or groups of atoms to these properties can be assessed.

The Bader partitioning method, however, does not allow for the partitioning of properties between chemical bonds. As chemistry is concerned with the manipulation of bonds and not atoms, the development of a method that allows the partitioning of properties among bonds is essential to the developing field of molecular design. The present disclosure addresses this and other needs.

### SUMMARY

The disclosure provides methods related to identifying the bond bundles of a molecule or solid. This is accomplished in a four step process: 1) one or more special charge density gradient paths are identified; 2) the special gradient surfaces containing the special gradient paths are identified; 3) these define the surfaces of a polyhedron known as an irreducible bundle; and 4) these irreducible bundles are combined to form the bond bundle.

First, special charge density gradient paths are identified. This is accomplished by defining constant charge isosurface in the molecule. The magnitude of the charge density gradient vectors is then mapped onto the constant charge isosurface. One or more minima, maxima, and/or saddle points of the charge density gradient vectors on the isosurface are then identified. A special charge density gradient path is defined by connecting the minima, maxima, and/or saddle points to the corresponding critical point along a gradient path.

Irreducible bundles are then constructed by combining the special charge density gradient paths. The irreducible bundles sharing a common bond critical point are joined to identify a bond bundle. Molecular properties can then be determined from the bond bundles.

Computer systems, computer implemented methods, and computer readable media configured to perform the methods are also provided.

### BRIEF DESCRIPTION OF THE DRAWINGS

FIG. 1 depicts a surface plot of charge density in benzene.

FIG. 2A depicts a constant charge non-continuous isosurface in which multiple surfaces surround naphthalene atoms.

FIG. 2B depicts the magnitude of the charge density gradient vectors mapped to the constant charge isosurface of FIG. 3A.

FIG. 2C depicts the maxima, minima, and saddle points of the charge density mapped to the constant charge isosurface.

FIG. 2D depicts a special charge density gradient path between a ring critical point and a carbon atom of naphthalene as determined by identifying the saddle point of the mapping.

FIG. 3A depicts a constant charge isosurface including atom critical points and bond critical points of naphthalene.

FIG. 3B depicts mapping charge density gradient vectors of naphthalene to the constant charge isosurface in FIG. 3A.

FIG. 3C depicts a special charge density gradient path between the bond CP and the ring CP.

FIG. 4A depicts a contour plot of the charge density in the molecular plane of ethene.

FIG. 4B depicts a contour plot of the charge density in a perpendicular plane containing the carbon-carbon axis.

FIG. 5A depicts a special gradient paths forming the edges of an irreducible bundle from FIG. 4.

FIG. 5B depicts a zero-flux surfaces that contain the edges of the irreducible bundle.

FIGS. 6A-D depicts the bond bundles near a carbon-carbon bond path for: A) ethane, B) benzene, C) ethylene, and D) acetylene.

FIG. 7 depicts bond bundle identification of benzene.

FIG. 8 is a block diagram of a computer system that may be used for determining a property of a molecule or a solid according to the present disclosure.

FIGS. 9A-9E are flow charts of a respective process of the computer system of FIG. 8.

### DETAILED DESCRIPTION

The disclosure provides methods, computer implementable methods, computer systems, computer readable media, and graphics used to model chemical structures and determine chemical properties of molecules. These include methods of identifying special gradient paths in the charge density. The special gradient paths partition space into irreducible bundles, which can be combined to produce bond bundles. These can then be used to predict properties of open systems, e.g. systems such as molecules and surfaces. The output includes graphical representations of special charge density gradient paths, irreducible bundles, bond bundles, and molecular properties.

### I. Correlating Charge Density with Molecular Structure and Bonding

It is known from the Hohenberg-Kohn theorem that ground-state molecular properties are a consequence of the charge density, a scalar field denoted as ρ(r). The charge density must also contain the essence of a molecule's structure, which can be described topologically in terms of its critical points (CPs)—the zeros of the gradient of this field, as described, for example, by Bader, R. F. W., Atoms in Molecules: A Quantum Theory, Clarendon Press: Oxford, U K, 1990; Zou, P. F.; Bader, R. F. W., A Topological Definition of a Wigner-Seitz Cell and the Atomic Scattering Factor, Acta Crystallographica A 1994, 50, 714-725; and Bader, R. F. W.; Nguyen-Dang, T. T.; Tal, Y., Quantum Topology of Molecular Charge Distributions II: Molecular Structure and its Charge, The Journal of Chemical Physics 1979, 70, (9), 4316-4329.

There are four kinds of CPs in three-dimensional space: a local minimum, a local maximum, and two kinds of saddle point. These CPs are denoted by an index, which is the number of positive curvatures minus the number of negative curvatures. For example, a minimum CP has positive curvature in three orthogonal directions and is denoted as a (3, 3) CP. The first number is simply the number of dimensions of the space, and the second number is the net number of positive curvatures. A maximum is denoted by (3, −3), since all three curvatures are negative. A saddle point with two of the three curvatures negative is denoted (3, −1), while the other saddle point is a (3, 1) CP.

It is possible to correlate topological properties of the charge density with elements of molecular structure and bonding. A bond path correlates with the ridge of maximum charge density connecting two nuclei, such that the density along this path is a maximum with respect to any neighboring path. The existence of such a ridge is guaranteed by the presence of a (3, −1) CP between nuclei. As such, the ridge CP between two nuclei is referred to as a bond CP. Other types of CPs have been correlated with other features of molecular structure. A (3, 1) CP is topologically required at the centre of ring structures, e.g. benzene. Accordingly, it is designated a ring CP. Cage structures are characterized by a single (3, 3) CP and again are given the descriptive name of cage CPs. A nucleus is always found to coincide with a maximum, a (3, −3) CP, and so is called an atom CP.

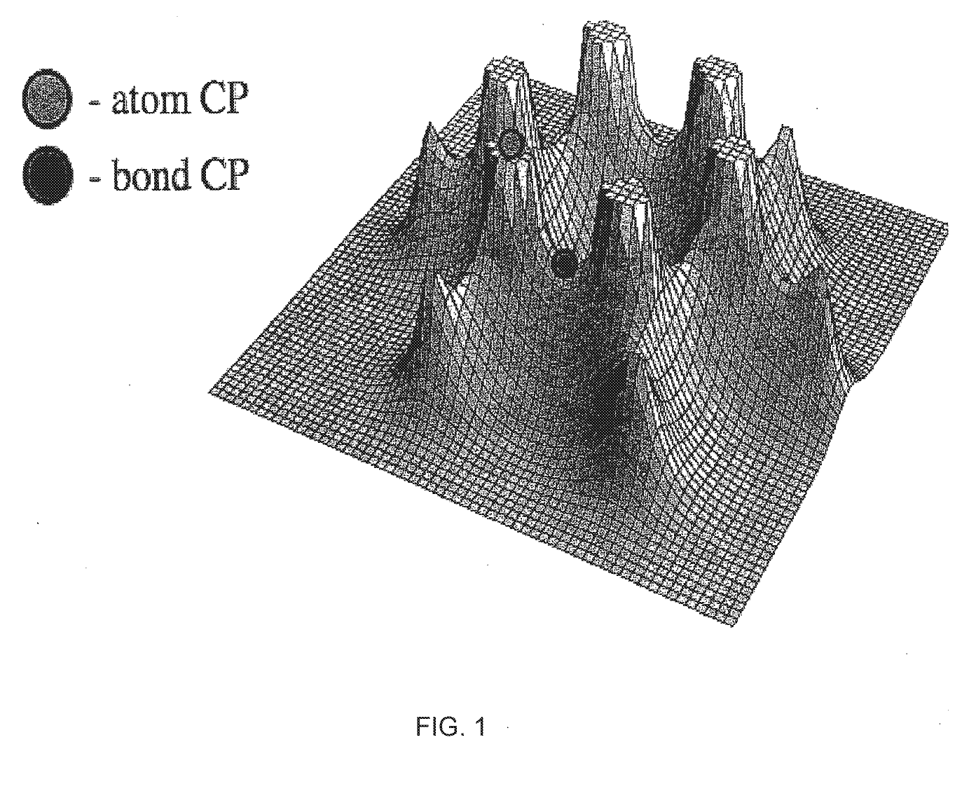

FIG. 1 shows a surface plot of the charge density in benzene. The six large maxima, one labelled with a solid black circle, correspond to the carbon atoms, while the six smaller maxima, only five of which are visible, correspond to the hydrogen atoms. Bond paths between adjacent atom CPs appear as the ridges of maximum charge density connecting the local maxima. The bond CP along one carbon-carbon bond path is labeled with a grey point. Finally, the minimum in the center of the 6-member carbon ring is the ring CP.

There are regions containing a single nucleus for which the properties are well-defined and additive to give the corresponding values of the molecular properties. For example, the energy of these regions can be summed to give the molecular energy. These regions are referred to as “atoms in molecules,” or “Bader atoms.” A sufficient condition for delineating the boundaries of Bader atoms is that they be bounded by a surface of zero flux, also known as a zero flux surface (ZFS), in the gradient of the charge density, in this proposal, simply called zero-flux surfaces.

Every molecule or solid can be partitioned into volumes Ωⱼ such that each is bounded by a surface S, where ∇ρ(r)·n(r)=0 for all r on S and n is the normal to S at r. The value of an observable Â over Ω is defined as,

A(Ω)≡ [symbol] Â [symbol] _{Ω}=∫_{Ω}^{dτ}ρ_{A}(r)

Where ρ_{A}(r)□ is the property density of Â, that is,

$${ρ}_{A} ( r ) = ( \frac{N}{2} ) \int d {τ}^{′} \{ {ψ}^{*} Â ψ + {( Â ψ )}^{*} ψ \}$$

N is the number of electrons in the system and τ□ are the spin and the space coordinates of N−1 of these. Only under the condition that the volumes are bounded by zero-flux surfaces is it found that a molecular value of the observable is given by a sum of its contributions from each Ωⱼ, in other words that

$$〈 Â 〉 = {\sum }_{j} A ( {Ω}_{j} ) .$$

In addition to Bader atoms, volumes bounded by zero flux surfaces that enclosed a single charge density minimum, i.e. a cage critical point, can also be constructed, as described, for example, by Pendas, A. M.; Costales, A., Luana, A., Ions in crystals: The Topology of the Electron Density in Ionic Materials I: Fundamental, Physical Review B 1997, 55, (7), 4275-4284.

In addition to these partitionings, Eberhart described the thinnest, chemically meaningful, partitioning of space into volumes bound by zero-flux surfaces as the irreducible bundle, see Eberhart, M., A Quantum Description of the Chemical Bond, Philosophical Magazine B 2001, 81, (8), 721-729

Each irreducible bundle is homeomorphic to a tetrahedron with its four vertices coincident with a ring CP, a bond CP, a cage CP, and an atom CP. The six edges of the tetrahedron correspond to gradient paths (GPs) (see Table 1). Some of these gradient paths are unique, for example, those connecting atom and bond CPs. On the other hand, there are an infinite number of GPs connecting other CPs, e.g. atom and cage. In such a case, it is the gradient path of minimum length that is taken to define the edge of an irreducible bundle. The four faces of which are then defined as the ZFSs of minimum area that contain its edges. All of the gradient paths contained in the irreducible bundle originate from the same cage CP and terminate at the same atom CP.

Irreducible bundles can be packed variously to give rise to any charge density topology. Bader atoms are the union of all irreducible bundles sharing the same atom CP. A bond bundle is defined as the union (combination) of irreducible bundles sharing a common bond CP. In this definition molecules can be partitioned into space-filling regions each containing a single bond critical point and bond path. The properties of this region are those of the bond and can be summed to give molecular properties.

### II. Identifying Bonds in Open Systems

Conventional methods of describing irreducible bundles described above suffer because one vertex of an irreducible bundle must be a cage CP and another vertex must be a ring CP, neither of which need exist in open systems such as molecules. For example, the conventional method of identifying irreducible bundles of benzene requires the identification of four critical points. However, the only cage point is an asymptotic minimum. Thus, the GPs of shortest length connecting this cage point to the ring, bond, and atom points cannot be located via the conventional approach. Therefore, the irreducible bundles cannot be constructed.

The methods disclosed herein resolve this difficulty by bypassing the requirement to identify all critical points in the open system. This is accomplished by identifying the special gradient paths in the charge density, referred to here as special gradient paths. These paths of least steep, steepest, and saddle descent are the edges of the irreducible bundles. As they are topologically required features of the charge density, they can be defined in the absence of cage and ring CPs.

A. Identifying Special Charge Density Gradient Paths

The methods disclosed herein address identification of special gradient paths in the charge density by first defining three dimensional constant charge isosurface in the molecule. The magnitude of the gradient of the charge is then mapped to the constant charge isosurface, referred to here as the mapping. One or more minima, maxima, and/or saddle points of the charge density gradient vectors are identified on the isosurface. A single gradient path passes through each of these critical points in the mapping. These are referred to as special gradient paths. The special gradient paths are thus the paths connecting the critical point contained within the charge isosurface with a minimum, maximum, or saddle point in the magnitude of the gradient of the charge density on an isosurface of constant charge.

Each of these steps is discussed in more detail below.

1. Constant Charge Isosurface

In a first step, a constant charge isosurface around the molecule is chosen. Generally, the isosurface forms one or more closed, two dimensional surfaces. In various embodiments, the constant charge isosurface can thus include multiple discontinuous surfaces each surrounding a discrete CP, multiple charge density surfaces surrounding groups of CPs, or a single constant charge isosurface surrounding all the CPs of a molecule.

By definition, every point on the constant charge isosurface has the same charge. The choice of isosurface is not critical, provided that the value of the isosurface is less than the value of the charge density at the critical point used to construct the particular special gradient path. In certain embodiments, the magnitude of charge of the constant charge isosurface is selected as an arbitrary value. In other embodiments, the magnitude of the constant charge is pre-selected to include all atom CPs in a molecule, all bond CPs in a molecule, all ring CPs in a molecule, or all the CPs in a molecule (excluding the asymptotic minimum).

The constant charge isosurface is found from the known charge distribution of the molecule. The charge distribution can be found by any method known in the art, including computational and empirical methods.

In various computer implemented methods, potentials, charge density fields, and other properties of the molecule can be represented mathematically using any coordinate systems known in the art.

2. Mapping the Magnitude of the Charge Density Vector

In the methods disclosed herein, the magnitude of the charge density gradient vector |∇ρ|_{Ω} is determined and mapped to the constant charge isosurface. |∇ρ|_{Ω}, is a scalar field and hence upon this two dimensional surface, |∇ρ|_{Ω} has its own topology, with local maxima, minima and saddle points.

The charge density can be determined by any computational or experimental method known in the art. Computational calculation can include ab initio calculations known in the art such as those using Hartree-Fock or Density Functional methods as described in Levin Quantum Chemistry 2008 (Prentice Hall; 6 edition). Alternatively, the charge density can be determined by X-ray diffraction measurements as are known in the art.

In computer implemented methods, computational subroutines can be used to map the magnitude of the charge density gradient fields to the constant charge isosurface. The magnitude of the charge density gradient field on the isosurface can be calculated from the charge density.

3. Identifying One or More Maxima, Minima, and/or Saddle Points on the Charge Density Isosurface to Identify Special Charge Density Gradient Paths

One or more minimum, maximum, and/or saddle points on the constant charge surface are then identified. The maxima and minima can be local or global maxima and minima. Through each identified maximum, minimum, and/or saddle point there passes a special gradient path, of steepest, least steep or saddle descent respectively. The special gradient path can be represented as a graphical representation.

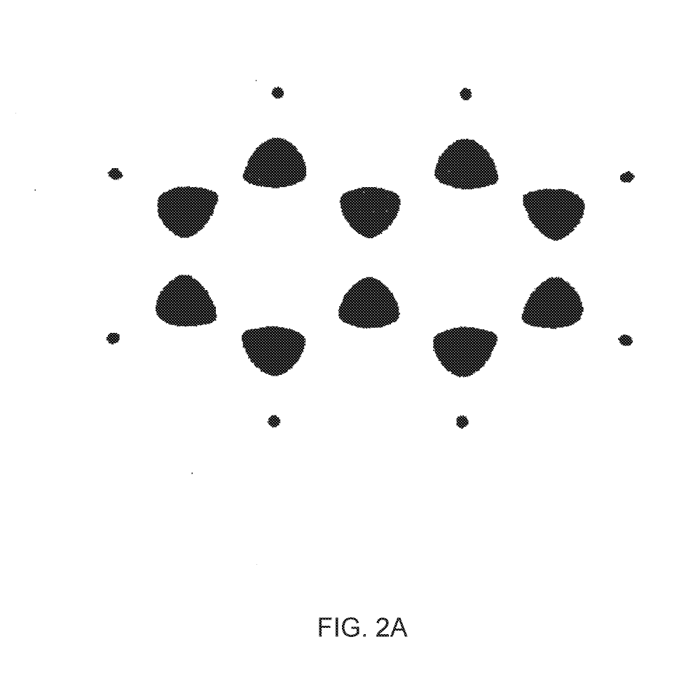

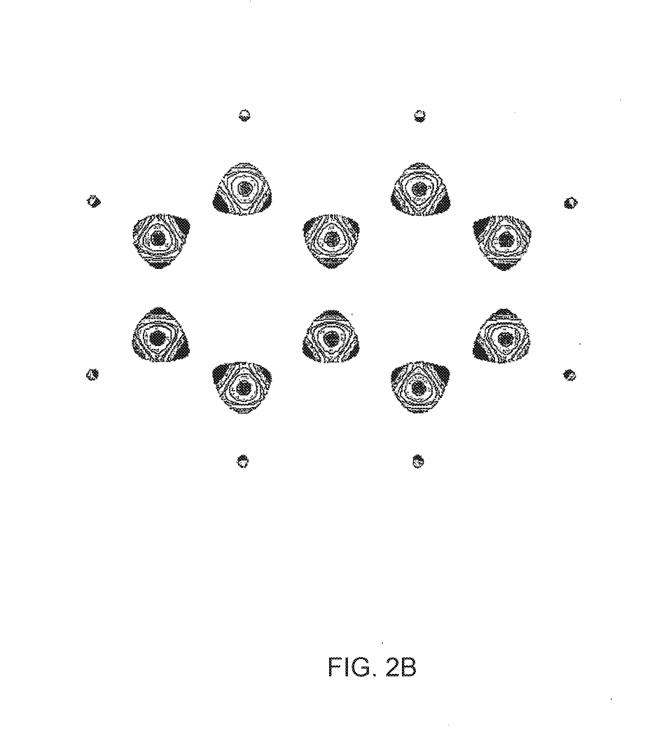

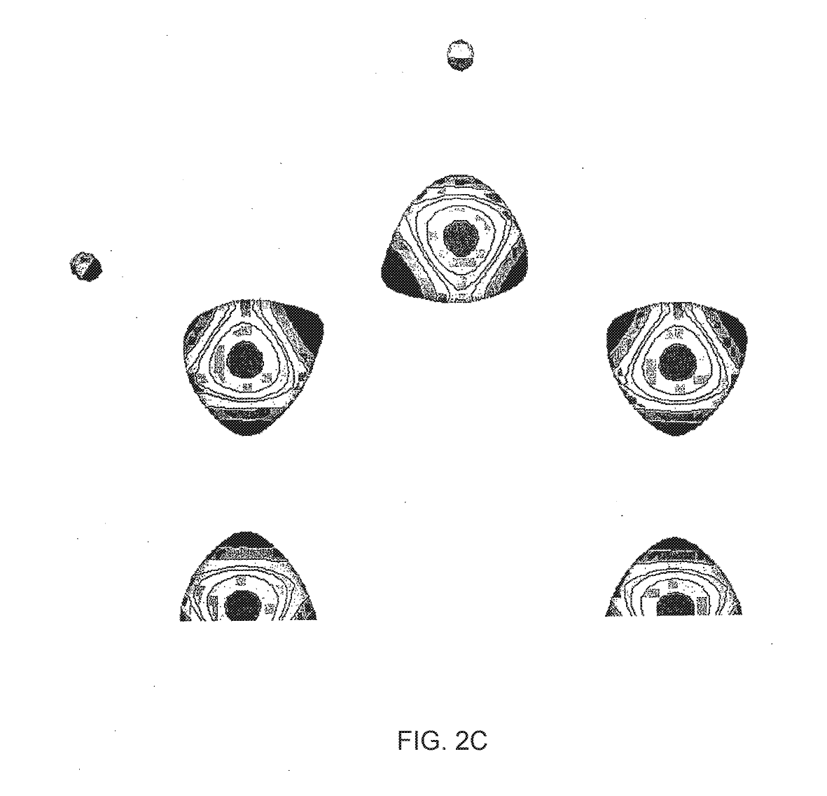

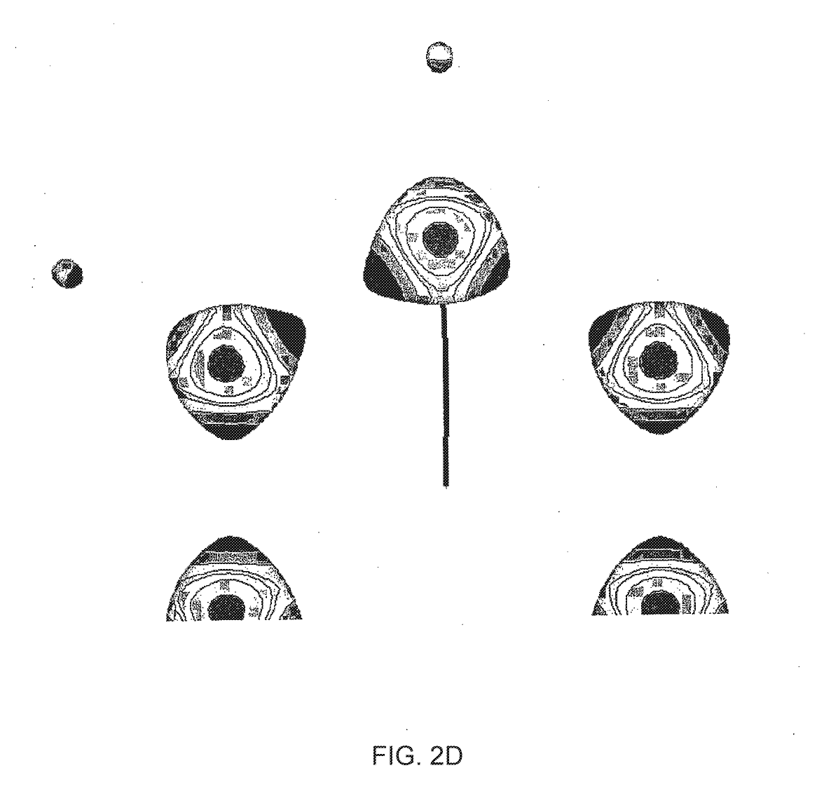

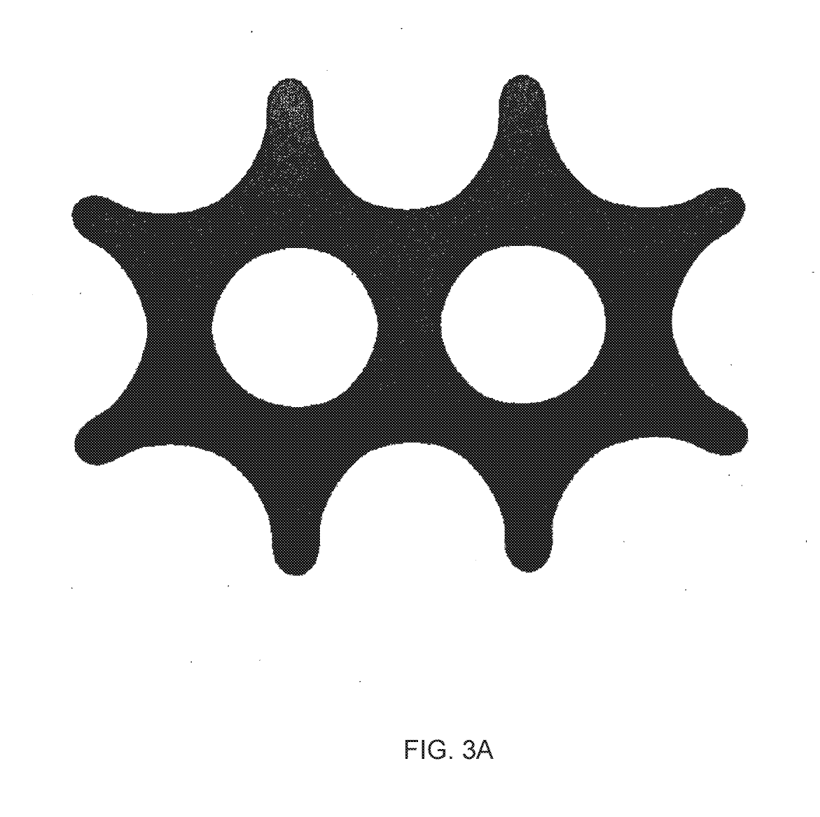

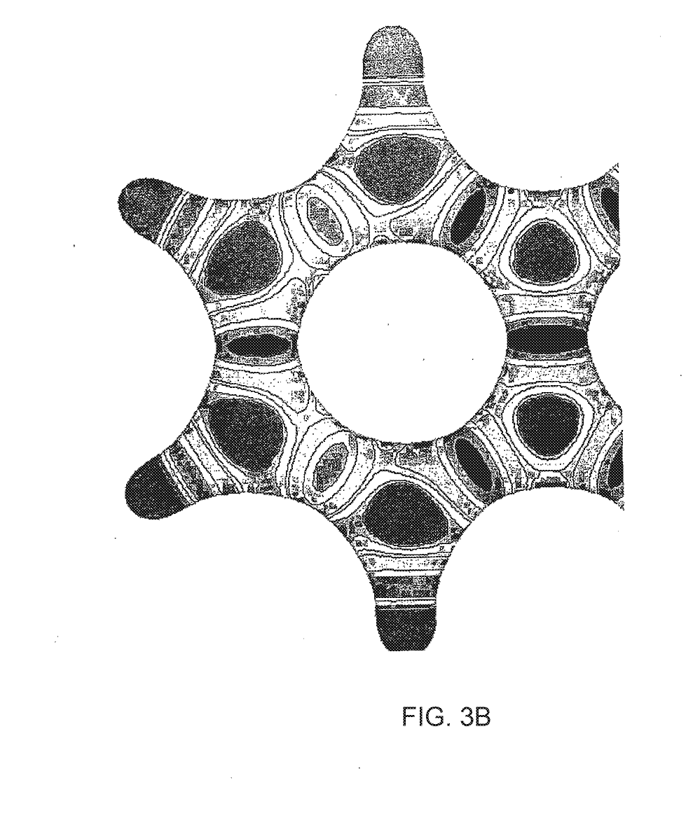

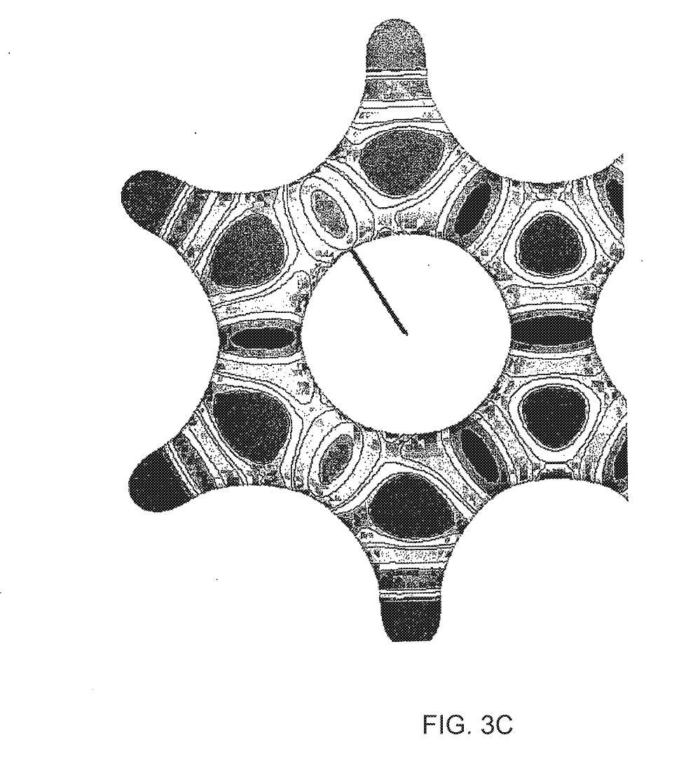

An example of a computer implemented method for identifying special paths for representative molecule naphthalene is depicted in FIGS. 2 and 3. Naphthalene has two cyclohexyl aromatic rings sharing a common aromatic bond. Special gradient paths, irreducible bundles formed from these paths, and ultimately bond bundles formed from the irreducible bundles can be determined.

In FIG. 2A, a constant charge isosurface is first selected to include the charge densities surrounding only atom CPs in the molecule. The constant charge isosurface thus includes several spatially unconnected surfaces within the molecule surrounding each atom carbon and hydrogen atom.

The magnitude of the charge density gradient vectors are then mapped to the constant charge isosurface selected in FIG. 2A. FIG. 2B depicts a mapping of the charge density gradient vectors to the constant charge isosurface of naphthalene.

The minima, maxima, and/or saddle points of the magnitude of the charge density gradient vectors mapped to the constant charge isosurface are then identified. FIG. 2C depicts the magnitude of the charge density gradients mapped to the constant charge density isosurface for naphthalene. In certain embodiments, the minima, maxima, and/or saddle points are found by identifying zeros in the gradient of the mapping function.

The gradient paths passing through the minimum, maximum, and/or saddle point of the mapping are the special gradient paths. FIG. 2D depicts the connection between a saddle point and a carbon atom critical point of naphthalene. Another saddle point from the bond CP to atom CPs can be constructed. The special gradient paths that lie between a) each bond CP and atom CP, b) ring CP and atom CP, and c) cage CP and atom CP are thus determined.

The special gradient paths between a) the ring CP and bond CPs, b) cage CPs and bond CPs, and c) cage CPs and ring CPs are then determined by selecting a second constant charge isosurface. In FIG. 3A, a second constant charge isosurface is selected that includes the carbon atom CPs as well as the bond CPs between the naphthalene carbon atoms. FIG. 3B depicts the mapping on the constant charge isosurface. The maxima, minima, and saddle points are then identified.

The gradient path that passes through a minima of the mapping and terminates at the bond CP is a special gradient path that connect the cage CP at infinity to the bond CP. Thus it is not necessary to locate the CP at infinity in order to determine the special charge density gradient path.

Those of skill in the art will recognize that while separate constant charge isosurfaces may be defined in the determination of different special charge density gradient paths, in other embodiments a single charge density gradient path may be selected.

B. Constructing Irreducible Bundles and Bond Bundles

The special charge gradient paths can then be used to form an irreducible bundle. Irreducible bundles are polyhedra formed from a “bundle” of gradient paths with a common origin and terminus. The vertices of irreducible bundles are critical points and the edges are gradient paths connecting critical points. In the present methods, the edges of an irreducible bundle coincide with special gradient paths and so can be identified without first locating all the irreducible bundles vertices. The faces of the irreducible bundle are the minimum area surfaces of zero-flux in the gradient of the charge density that are bounded by special gradient paths.

In computer implemented methods for constructing irreducible bundles, computational subroutines can be used to combine the irreducible bundles. The irreducible bundles can be represented as a tangible output such as a graphical representation of a computer output. A bond bundle is then constructed from the combination of irreducible bundles sharing a common bond CP.

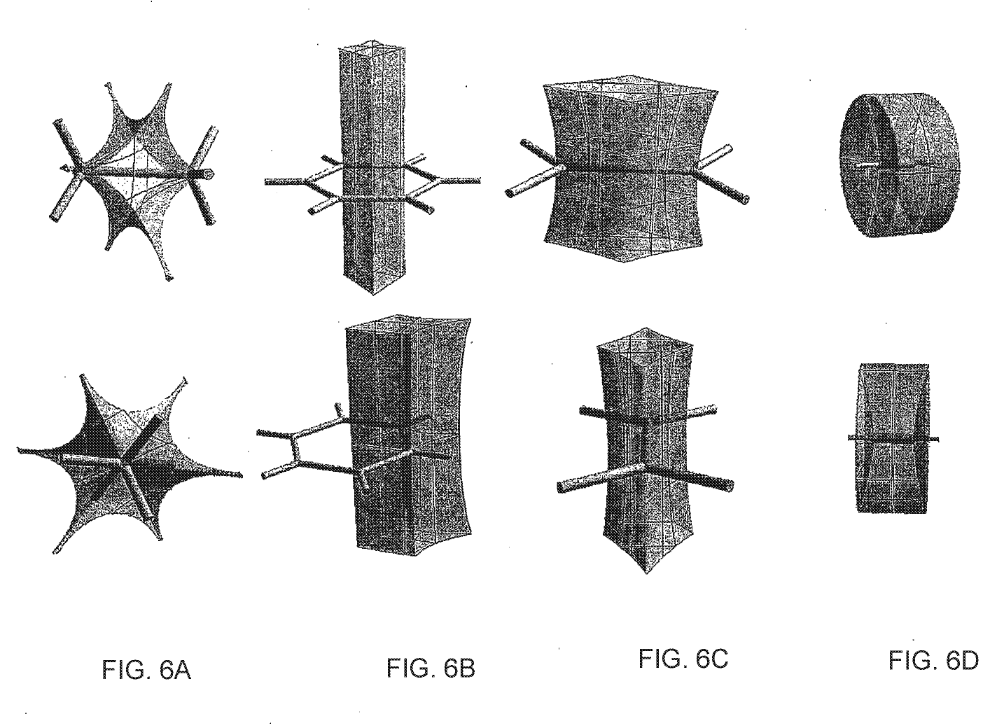

FIG. 6 shows the variation in the carbon-carbon bond bundle through the series ethane, benzene, ethene, and acetylene. The bond bundles near the respective C—C bond paths for: A) ethane, B) benzene, C) ethylene, and D) acetylene. All bond bundles shown have infinite extent but have been truncated to facilitate visualization. Ethane is truncated with respect to an intersecting sphere. Benzene and ethylene are truncated in the ±z-directions, and acetylene is truncated relative to an intersecting cylinder.

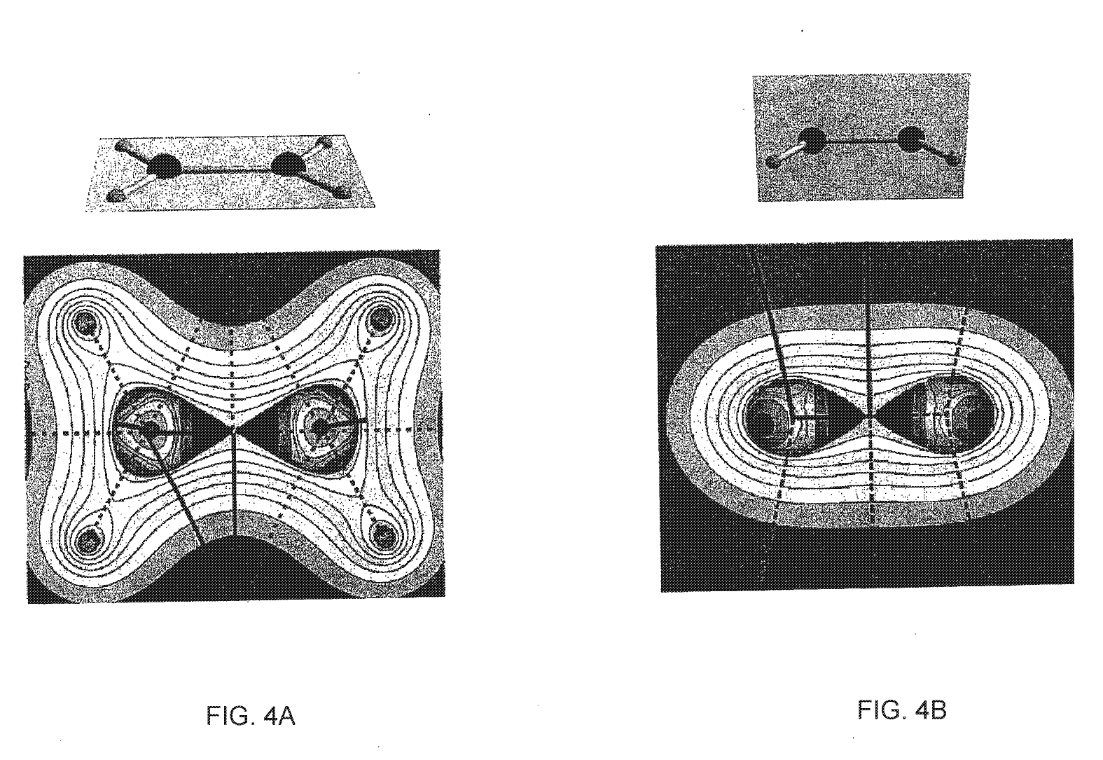

To illustrate the identification of irreducible and bond bundles, consider the planar ethene molecule depicted in FIG. 4 and FIG. 6C. Referring to FIGS. 4A and 4B, the special gradient paths around the carbon atom CP and carbon-carbon bond CP are shown as solid and dashed lines. In FIG. 4A, there are six special gradient paths in the molecular plane terminating at a carbon atom CP. Three of these are bond paths (gradient paths of least steep descent) lying between the carbon-carbon bond and each of the carbon-hydrogen bonds. The three paths that originate at infinity are of saddle type descent. In FIG. 4B, the remaining two special gradient paths terminating at the carbon atom CP and contained in the perpendicular plane are gradient paths of steepest descent.

Due to its symmetry, special gradient paths lie in either the molecular plane or the perpendicular plane containing the carbon nuclei. Around the atom CP at each carbon site, and in the molecular plane, there are six special gradient paths, three each of saddle and least steep descent. The latter correspond to the bond paths in this plane—two carbon-hydrogen and one carbon-carbon bond. In the perpendicular plane, one finds two additional gradient paths of steepest descent. Around the carbon-carbon bond CP, one finds six special gradient paths, two of saddle descent in the molecular plane, two of least steep descent in the perpendicular plane, and the two paths that extend from the bond point to the carbon atom CPs and form the carbon-carbon bond path.

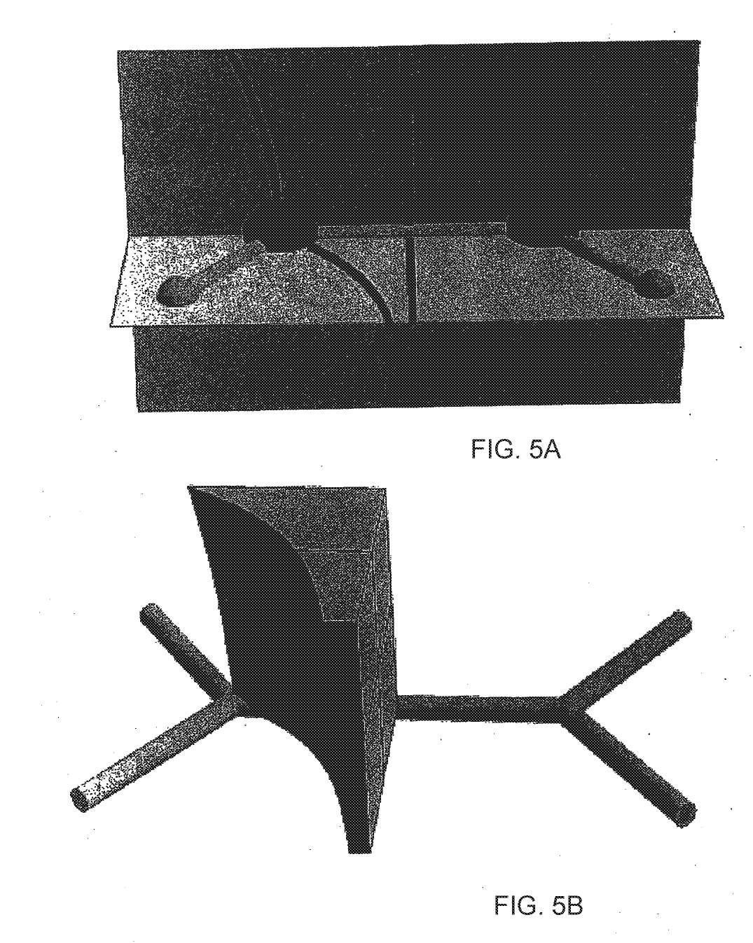

The special gradient paths shown as solid lines are the edges of a single irreducible bundle. As shown in FIG. 5A, these special gradient paths lie along the edges of irreducible bundles. The zero-flux surfaces that contain these edges are shown in FIG. 5B and together form the boundary of an irreducible bundle. Note that symmetry requires there be eight irreducible bundles sharing the carbon-carbon bond CP. There are eight irreducible bundles sharing, as one of their vertices, the carbon-carbon bond CP. Taken together, these constitute the carbon-carbon bond bundle of ethene depicted in FIG. 6C.

Taking benzene in FIG. 6B as another example, a bond bundle is made from the union of eight irreducible bundles around a single carbon-carbon bond of a benzene ring. Each irreducible bundle has four critical points as vertices: an atom CP, a bond CP, a ring CP, and a cage CP. Special charge density gradient paths connect the CPs. A first irreducible bond bundle is found by extending a special charge density gradient path from the atom CP along a central path to the center of the ring. A second special charge density gradient path is found by extending from the midpoint of the bond CP to one of the adjacent carbon atom CPs. A third special charge density gradient path extends from the ring CP to the bond CP. This is the base of the irreducible bundle. The volume of the irreducible bond bundle extends from each atom CP, bond CP, and ring CP above the plane of the benzene ring to cage CPs at infinity.

The base of a second irreducible bundle is formed from the same ring CP and bond CP, and to the second atom CP in the bond. The volume of the irreducible bundle extends above the plane of the benzene ring to cage CPs. Third and fourth irreducible bundles extend below the plane of the benzene ring to cage points of the benzene ring.

C. Calculating Bond Properties

Using the above construction a molecule can be partitioned into non-overlapping, space-filling regions each containing a single bond. Each of these regions is bounded by a non-arbitrary surface of zero flux in the gradient of the charge density. Hence, the energy (or other extensive properties) of a bond can be determined by evaluating the appropriate integral over the bond bundle, i.e. for a property given by the quantum mechanical observable A, the value of bond property A is given by,

A(Ω)≡ [symbol] Â [symbol] _{Ω}=∫_{Ω}^{dτ}ρ_{A}(r)

Where Ω is the region of space coinciding with the bond bundle and ρ_{A}(r)□ is the property density of Â, that is,

$${ρ}_{A} ( r ) = ( \frac{N}{2} ) \int d {τ}^{′} \{ {ψ}^{*} Â ψ + {( Â ψ )}^{*} ψ \}$$

N is the number of electrons in the system and τ′□ are the spin and the space coordinates of N−1 of these.

Those versed in the art can calculate properties given for any quantum operator. Numerous molecular properties can be calculated as described in Levin Quantum Chemistry 2008 (Prentice Hall; 6th edition). For example, the bond energy can be found when A is the Hamiltonian operator. Replacing A by the identity operator gives the number of electrons in a bond. The numerical methods for evaluating these integrals are known to those versed in the art, see for example, Numerical Recipes (W. H.; Teukolsky, S. A.; Vetterling, W. T.; Flannery, B. A., Numerical Recipes: The Art of Scientific Computing, Third Edition (2007), 1256 pp. Cambridge University Press, ISBN-10: 0521880688).

Numerous properties can be calculated using, for example, numerical recipes as described in Press, W. H.; Teukolsky, S. A.; Vetterling, W. T.; Flannery, B. A., Numerical Recipes: The Art of Scientific Computing, Third Edition (2007), 1256 pp. Cambridge University Press, ISBN-10: 0521880688, incorporated herein by reference in its entirety. These include integrations over volume, that are described in Numerical Recipes above and include but are not limited to electron density, Laplacian of Rho, Lagrangian kinetic energy density, Hamiltonian kinetic energy density, Virial Field Function, Energy of bundle, Missing Information Function, Average value of Rho/r, Average value of Rho*r, Average value of Rho*(r²), Average value of Rho*(r⁴), Average value of Grad(Rho)*(Vector R)/r, Average value of Grad(Rho)*(Vector R), Average value of Grad(Rho)*(Vector R)*r, Average value of Grad(Rho)*(Vector R)*(r²), Electric Dipole (x), Electric Dipole (y), Electric Dipole (z), Attraction of density A by nucleus A, Attraction of density A by nucleus A (con.), Attraction of density A by all nuclei, Attraction of density A by all nuclei (con.), Hartree-Fock Energy, Potential energy of repulsion (con.), Total potential energy of bundle, Atomic Quadruple Moment Tensor (xx), Atomic Quadruple Moment Tensor (xy), Atomic Quadruple Moment Tensor (xz), Atomic Quadruple Moment Tensor (yy), Atomic Quadruple Moment Tensor (yz), Atomic Quadruple Moment Tensor (zz), Force exerted on nucleus A by density of A (x), Force exerted on nucleus A by density of A (y), Force exerted on nucleus A by density of A (z), Force exerted on all nuclei by density of A (x), Force exerted on all nuclei by density of A (y), Force exerted on all nuclei by density of A (z), Rho*Laplacian, Total integrated volume (at some isosurface value “x”), Electron density over integrated volume (at some isosurface value “x”), Electron density over integrated volume (0.002 au isosurface), Basin Virial, Surface Virial, Ehrenfest force (x), Ehrenfest force (y), Ehrenfest force (z), OVERLAP, and Atomic Overlap Matrix (0.5*n*(n+1) properties, where n is the number of molecular orbitals.

Also, these include integrations over surfaces, that are described in Numerical Recipes above and include but are not limited to Laplacian of Rho, Lagrangian kinetic energy density, Hamiltonian kinetic energy density, x gradient of Rho*surface normal, Hypervirial Gradient Function (n=−1), Bundle A, Hypervirial Gradient Function (n=−1), Bundle B, Hypervirial Gradient Function (n=0), Bundle A, Hypervirial Gradient Function (n=0), Bundle B, Hypervirial Gradient Function (n=1), Bundle A, Hypervirial Gradient Function (n=1), Bundle B, Hypervirial Gradient Function (n=2), Bundle A, Hypervirial Gradient Function (n=2), Bundle B, Hypervirial Gradient Function (n=−1), Total, Hypervirial Gradient Function (n=0), Total, Hypervirial Gradient Function (n=1), Total, Hypervirial Gradient Function (n=2), Total, Hypervirial Gradient Function (n=−1), Bundle B, Virial of force exerted on surface of A, Virial of force exerted on surface of B, Total virial of force exerted on surface, Total force exerted on electrons of bundle A (x), Total force exerted on electrons of bundle A (y), Total force exerted on electrons of bundle A (z), Gradient of force exerted on electrons of bundle A, and Total integrated area.

### III. Computer Implemented Methods

While the disclosed embodiments are described in specific terms, other embodiments encompassing principles of the invention are also possible. Further, operations may be set forth in a particular order. The order, however, is but one example of the way that operations may be provided. Operations may be rearranged, modified, or eliminated in any particular implementation while still conforming to aspects of the invention.

In computer implemented methods of identifying special charge density gradient paths, computational subroutines can be used to select the constant charge isosurface. Multiple constant charge isosurfaces can be selected as described above. For example, a subroutine designed to select a constant charge isosurface can be designed to select individual atoms, atoms and bonds, or atoms, bonds, and ring points. Since the non-infinite CPs of a given molecule have a known location, an isosurface can be defined that surrounds atom CPs, bond CPs, ring CPs, and/or non-infinite cage CPs in a given molecule in any combination. If a selected constant charge isosurface does not surround the selected CPs, it can be reset to surround the CPs.

In one embodiment, a computer implemented method for identifying one or more special charge density gradient paths comprises identifying one or more special charge density gradient paths according to the method described herein. In some embodiments, the computer implemented method may further comprise producing a graphical representation thereof.

### IV. Computer Systems

Embodiments within the scope of the invention include computer systems configured to perform the methods disclosed herein and, in some embodiments, produce a graphical representation thereof. In one embodiment, a computer system for identifying one or more special charge density gradient paths comprises identifying one or more special charge density gradient paths according to the method disclosed herein. In some embodiments, the computer implemented method may further comprise producing a graphical representation thereof.

Computer systems are generally well-known in the art. Those skilled in the art will appreciate that aspects of the invention may be practiced in computing environments or network computing environments with many types of computer system configurations, including personal computers, hand-held devices, multi-processor systems, microprocessor based or programmable consumer electronics, network PCs, minicomputers, mainframe computers, and the like. Various embodiments discussed herein, including embodiments involving a satellite or cable signal delivered to a set-top box, television system processor, or the like, as well as digital data signals delivered to some form of multimedia processing configuration, such as employed for IPTV, or other similar configurations can be considered as within a network computing environment. Further, wirelessly connected cell phones, a type of hand-held device, are considered as within a network computing environment. For example, cell phones include a processor, memory, display, and some form of wireless connection, whether digital or analog, and some form of input medium, such as a keyboards, touch screens, etc.

Hand-held computing platforms can also include video on demand type of selection ability. Examples of wireless connection technologies applicable in various mobile embodiments include, but are not limited to, radio frequency, AM, FM, cellular, television, satellite, microwave, WiFi, blue-tooth, infrared, and the like. Hand-held computing platforms do not necessarily require a wireless connection. For example, a hand-held device may access multimedia from some form of memory, which may include both integrated memory (e.g., RAM, Flash, etc) as well as removable memory (e.g., optical storage media, memory sticks, flash memory cards, etc.) for playback on the device. Aspects of the invention may also be practiced in distributed computing environments where tasks are performed by local and remote processing devices that are linked (either by hardwired links, wireless links, or by a combination of hardwired or wireless links) through a communications network. In a distributed computing environment, program modules may be located in both local and remote memory storage devices.

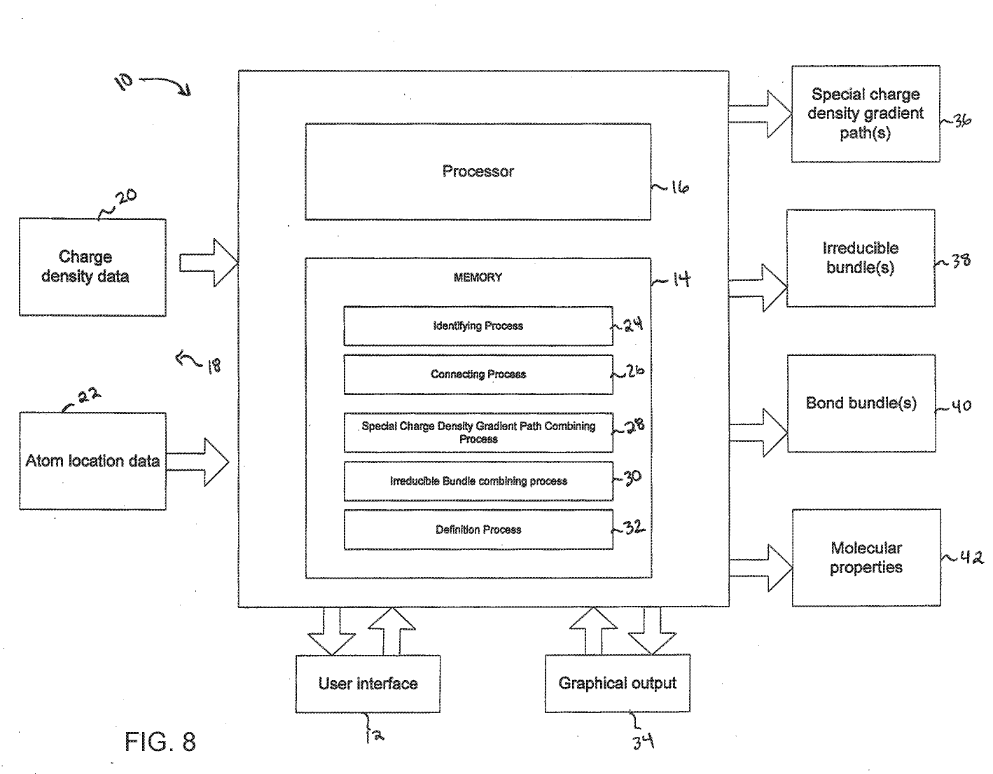

FIG. 8 illustrates the components of a computer system 10 that may be configured to perform the methods disclosed herein. The computer system 10 may include a user interface 12, memory 14, a processor 16, raw data, such as charge density data 20 and atom location data 22, an identifying process 24, a connecting process 26, a special charge density gradient path combining process 28, an irreducible bundle combining process 30 and a definition process 32. Outputs may include a graphical output 34, determination, calculation or identification of: special charge density gradient path(s) [block 36], irreducible bundles [block 38], bond bundles [block 40] and molecular properties [block 42] according to the methods described herein.

In certain embodiments, and as can be understood from FIG. 8, computer systems 10 include a processor 12 configured to perform the methods disclosed herein and capable of executing program instructions. Accordingly, the processor 16 may include any general purpose programmable processor or controller for executing application programming. Alternatively, the processor 16 may comprise a specially configured application specific integrated circuit (ASIC). The processor 16 generally functions to run a programming code implementing various functions performed by the processes 24, 26, 28, 30, 32 or other system component being implemented. For example, such functions may include functions enabled through the execution of programming code or other application instructions.

The computer system 10 may additionally include memory 14 for use in connection with the execution of programming by the processor 16, and for the temporary or long term storage of data or program instructions. For example, the memory may be used in connection with the operation of applications. The memory 14 may comprise solid-state memory resident, removable or remote in nature, such as DRAM and SDRAM and as described previously. Examples of particular applications that may be stored in the memory 14 an identifying process 24, a connecting process 26, a special charge density gradient path combining process 28, an irreducible bundle combining process 30 and a definition process 32. The Raw data that may be input into the system includes the charge density data 20 and the atom location data 22. Such raw data may include a data set of raw data and may include data that describes characteristics of an actual molecule or a set of molecules. Examples of such data may include data representative of the spatial relationship of a molecule (e.g. the spatial relationship between atoms of a molecule such as data points representative of atom location) or charges surrounding the molecule (e.g. data points representative of charge density). The data may be input manually or stored in the memory of the computer system. The data points may be experimentally derived or calculated via computer software.

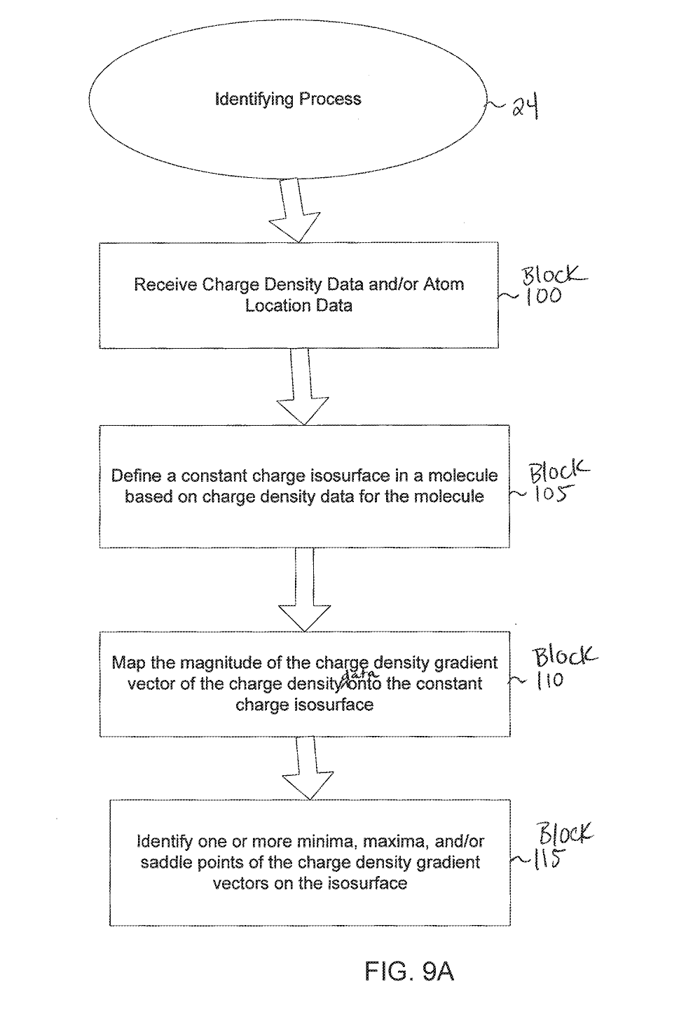

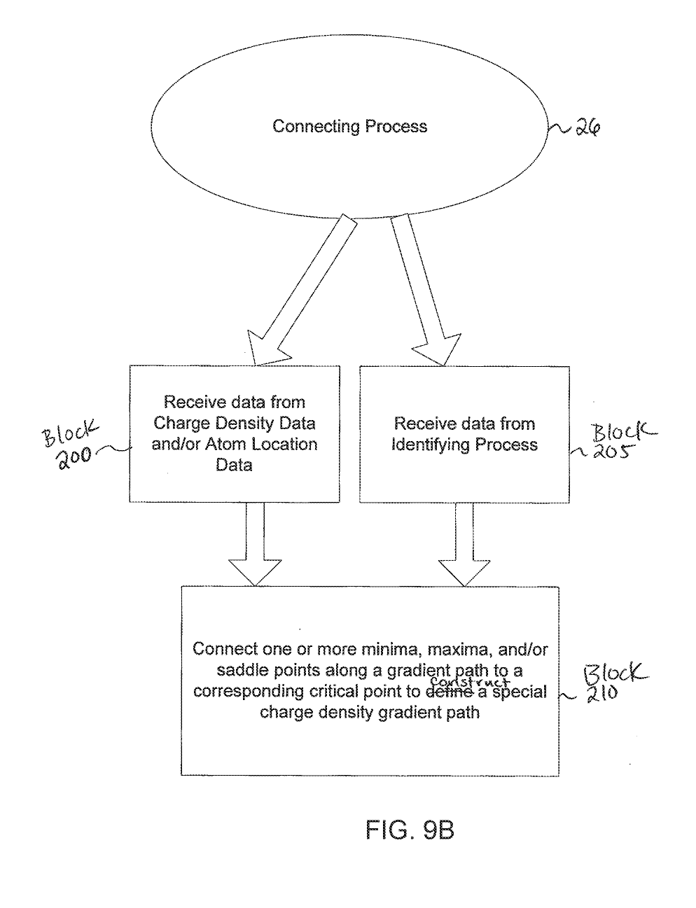

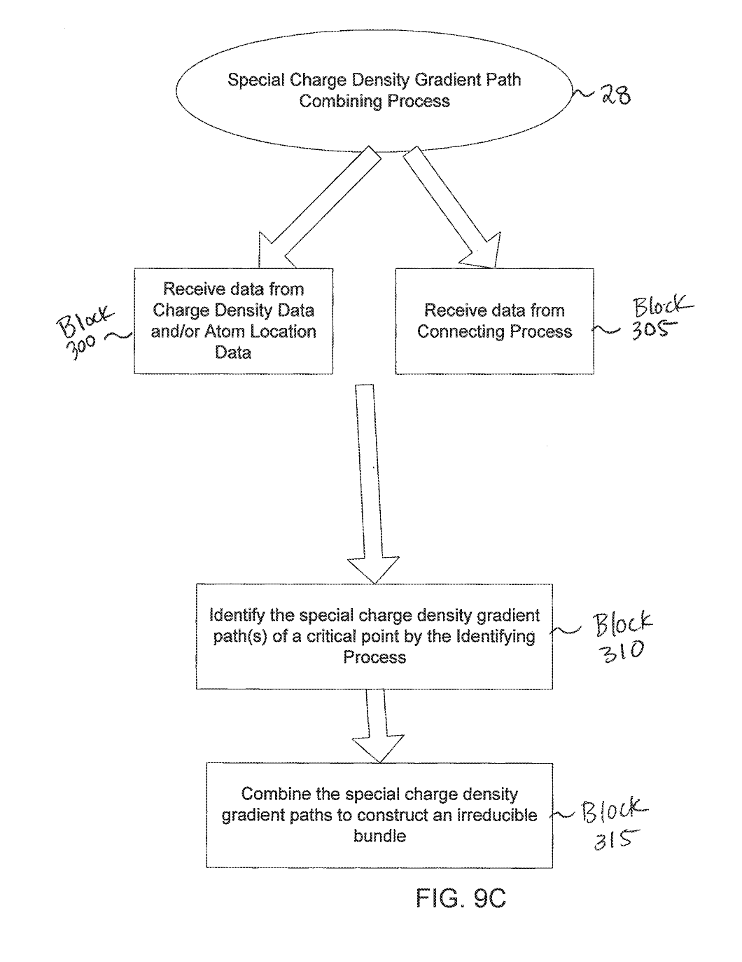

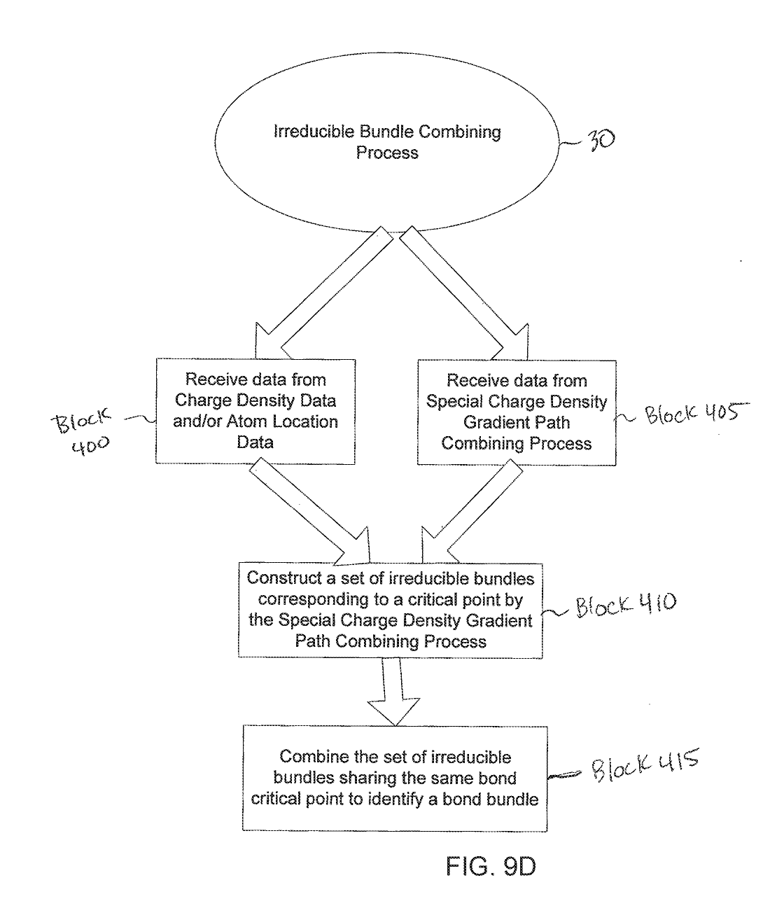

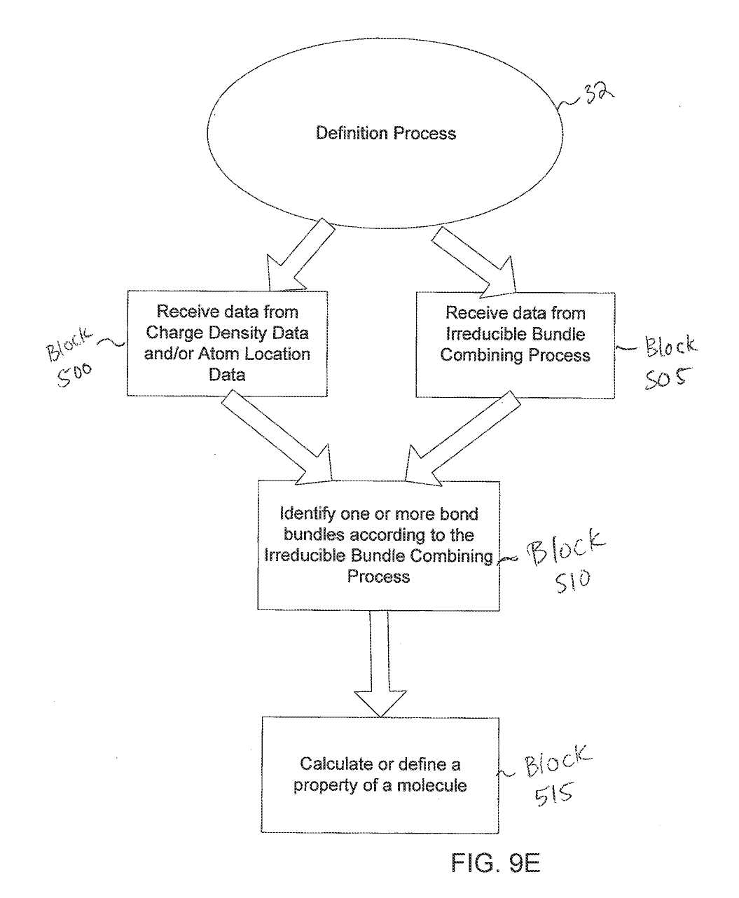

The computer system 10 can be configured to identify special charge density gradient paths of one or more chemical bonds as described above and herein via, for example, the identifying process 24 and the connecting process 26. As depicted in FIG. 9A, the identifying process 24 may include receiving charge density data, atom location data or other raw data [block 100], defining a constant charge isosurface in a molecule based on charge density data for the molecule [block 105], mapping the magnitude of the charge density gradient vector of the charge density onto the constant charge isosurface [block 110], and identifying one or more minima, maxima, and/or saddle points of the charge density gradient vectors on the isosurface [block 115]. As depicted in FIG. 9B, the connecting process 26 may include receiving data from the charge density data and/or atom location data [block 200], receiving data from the identifying process [block 205], and connecting one or more minima, maxima, and/or saddle points along a gradient path to a corresponding critical point to define a special charge density gradient path. [block 210].

The computer system 10 and/or processor 16 can be further configured to combine the special charge gradient paths corresponding to a CP to form an irreducible bundle as described herein via the special charge density gradient path combining process 28. As depicted in FIG. 9C, the special charge density gradient path combining process 28 may include receiving data from the charge density data and/or atom location data [block 300], receiving data from the connecting process [block 305], identifying the special charge density gradient path(s) of a critical point by the identifying process [block 310], and combining the special charge density gradient paths to construct an irreducible bundle [block 315]

The computer system 10 and/or processor 16 then identifies a bond bundle by combining the set of irreducible bundles sharing the same bond point as described herein via irreducible bundle combining process 30. As depicted in FIG. 9D, the irreducible bundle combining process 30 may include receiving data from the charge density data and/or atom location data [block 400], receiving data from the special charge density gradient path combining process [block 405], constructing a set of irreducible bundles corresponding to a critical point (CP) by the special charge density gradient path combining process [block 410], combining the set of irreducible bundles sharing the same bond critical point to identify a bond bundle [block 415]. First, the set of irreducible bundles corresponding to the CP is determined. A group of irreducible bundles corresponding to a CP form a bond bundle.

In other variations, the computer systems described herein can comprise a processor configured to calculate molecular properties of the compound, such as via the definition process 32. As depicted in FIG. 9E, the definition process 32 may include receiving data from the charge density data and/or atom location data [block 500], receiving data from the irreducible bundle combining process [block 505], identifying one or more bond bundles according to the irreducible bundle combining process [block 510] and calculating or defining a property of a molecule [block 515].

The computer system 10 may also produce a graphical representation or graphical output 28, such as shown in FIGS. 1-7B.

### V. Computer Readable Media

Embodiments within the scope of the present invention also include computer readable media for carrying or having computer-executable instructions or data structures stored thereon. Such computer-readable media may be any available media that can be accessed by a general purpose or special purpose computer. By way of example, and not limitation, such computer-readable media can comprise RAM, ROM, EEPROM, DVD, CD ROM or other optical disk storage, magnetic disk storage or other magnetic storage devices, or any other medium which can be used to carry or store desired program code means in the form of computer-executable instructions or data structures and which can be accessed by a general purpose or special purpose computer. When information is transferred or provided over a network or another communications link or connection (either hardwired, wireless, or a combination of hardwired or wireless) to a computer, the computer properly views the connection as a computer-readable medium. Thus, any such connection is properly termed a computer-readable medium.

Combinations of the above should also be included within the scope of computer-readable media. Computer-executable instructions comprise, for example, instructions and data which cause a general purpose computer, special purpose computer, or special purpose processing device to perform a certain function or group of functions. In one embodiment, a computer readable medium including computer executable instructions to, when implemented, perform the methods described herein, such as the method for identifying one or more special charge density gradient paths.

### VI. Example

The following non-limiting example describes an embodiment of the invention. It will be apparent to those skilled in the art that many modifications may be practiced without departing from the scope of the disclosure.

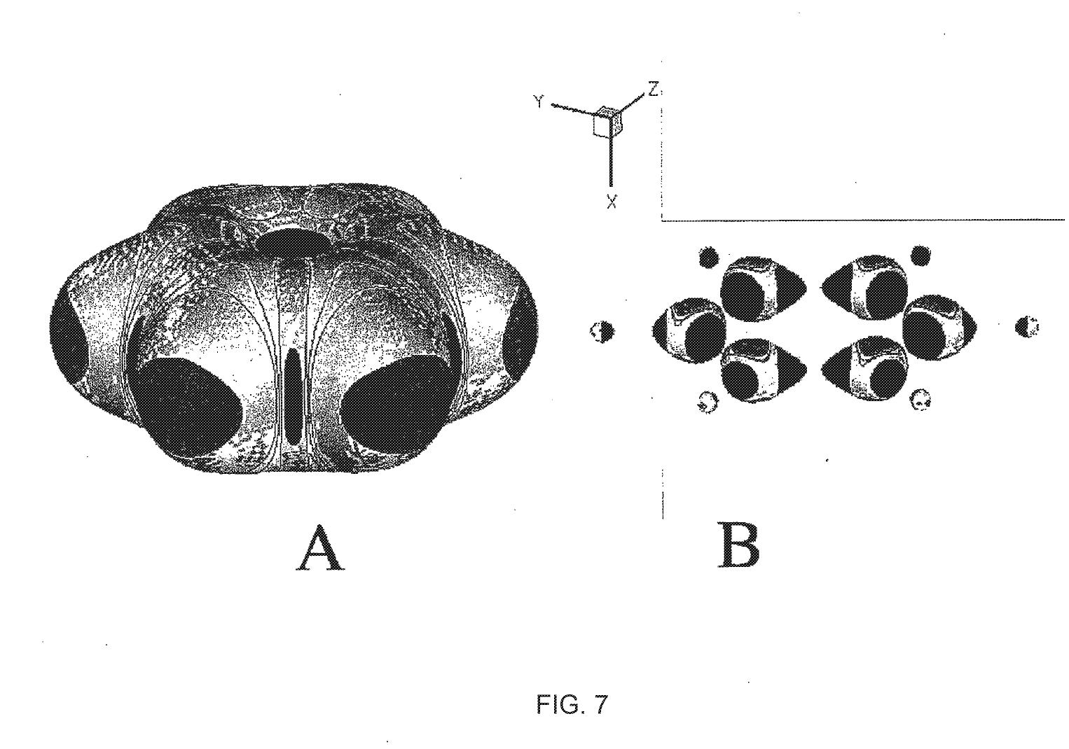

FIG. 7 illustrates the algorithm for bond bundle identification. As a first step, the CPs of the molecule are identified: a total of 12 maxima, 12 bond CPs, and 1 ring CP. Identification of the bond bundles in this case required location of the special gradient paths terminating at the ring and atom CPs. To identify the first set of these, a charge density isosurface whose value is less than p at the ring CP was selected. FIG. 7A, shows the mapping on a suitable isosurface, where ρ=0.01 electrons/bohr³. Maxima occur where the path of steepest descent intersect the isosurface. They originate at infinity and terminate at the hydrogen atom CPs. Two types of minima can also be seen. These are the intersections of GPs of least steep descent with the isosurface. Those in the yz plane, terminate at bond CPs, while the only path terminating at the ring CP is on the x-axis. This path makes up one edge of the benzene bond bundle shown in FIG. 6B.

The remaining special gradient paths terminate at atom CPs. In order to locate these, a new isosurface was selected. Its value was less than that of p at the atom CP but greater then that of ρ at the bond CPs. If not, the special gradient paths terminating at the bond CPs will make identification of those terminating at the atom CPs difficult. FIG. 7B shows the same benzene molecule with an isosurface value of ρ=0.31 electrons/bohr³. Inspection of the figure reveals saddle descent paths, terminating at the carbon atoms, lie in the yz plane. These paths are the remaining edges of the bond bundle seen in FIG. 6B.

The same general procedure can be repeated to identify the bond bundles for any molecule. The bond bundles through the series, ethane, benzene, ethene, and ethyne are shown in FIG. 6. The number of (valence) electrons in the bond (a property) was then determined by evaluating the aforementioned integrals over the bond bundle yielding (to a precision of ±0.25) 2, 3, 4, and 6 electrons for ethane, benzene, ethene, and ethyne respectively.

All references disclosed herein are hereby incorporated by reference in their entirety.

1-25. (canceled)

26. A method of partitioning a first molecule into at least one functional region to determine a property between chemical bonds of the molecule in order to design a second molecule by constructing one or more special charge density gradient paths of the first molecule to identify an irreducible bundle of the first molecule, the method comprising:
defining a constant charge isosurface in said first molecule based on charge density data for the first molecule, the isosurface forming one or more closed, two dimensional surfaces;
determining a magnitude of at least one charge density gradient vector of the charge density data and mapping the magnitude of the vector onto the constant charge isosurface;
identifying one or more minima, maxima, and/or saddle points of said charge density gradient vectors on said isosurface, wherein the minima, maxima and saddle points describe the charge density topologically and are defined in terms of an index which is the number of positive curvatures minus the number of negative curvatures;
constructing a special charge density gradient path by connecting said one or more minima, maxima, and/or saddle points along a gradient path to a corresponding critical point, wherein each special charge density gradient path represents a path of least steep, steepest or saddle descent that corresponds to an edge of an irreducible bundle;
combining said special charge density gradient paths to construct the irreducible bundle, the irreducible bundle comprising polyhedra formed from a bundle of gradient paths with a common origin and terminus, wherein a vertex of the irreducible bundle is a critical point, an edge of the irreducible bundle is a special gradient path connecting two critical points and a face of the irreducible bundle is a two dimensional ridge and is a minimum area surface of zero flux in the gradient of the charge density that is bounded by special gradient paths;
partitioning the molecule into non-overlapping unions of irreducible bundles, which are space filling regions, each region containing a single bond point and producing a graphical representation of the union of irreducible bundles to visualize that region of the molecule and associate that region with a property of the molecule, wherein each property of the region represents a property of the bond; and
producing the second molecule with desired properties by applying the information about the property of the first molecule and correlating the property with elements of molecular structure and bonding to design the second molecule.

27. The method of claim 26, wherein said critical point is a bond critical point, a ring critical point, a cage critical point or an atom critical point.

28. The method of claim 26, wherein the maximum and/or minimum is a local maximum and/or minimum.

29. The method of claim 26, further comprising the steps of
combining a set of irreducible bundles sharing a same bond critical point to identify a bond bundle; producing a graphical representation of the bond bundle to visualize a region of the molecule and associate that region with a property of the molecule; and
producing the second molecule with desired properties by applying the information about the property of the first molecule and correlating the property with elements of molecular structure and bonding to design the second molecule.

30. The method of claim 26, further comprising the step of calculating a property of the molecule.

31. A system of partitioning a first molecule into at least one functional region to determine a property between chemical bonds of the molecule in order to design a second molecule by constructing one or more special charge density gradient paths of the first molecule to identify an irreducible bundle of the first molecule, the system comprising:
a memory for storing computer readable code;
and a processor operatively coupled to the memory, the processor configured to:
define a constant charge isosurface in said first molecule based on charge density data for the first molecule, the isosurface forming one or more closed, two dimensional surfaces;
determine a magnitude of at least one charge density gradient vector of the charge density data and mapping the magnitude of the vector onto the constant charge isosurface;
identify one or more minima, maxima, and/or saddle points of said charge density gradient vectors on said isosurface, wherein the minima, maxima and saddle points describe the charge density topologically and are defined in terms of an index which is the number of positive curvatures minus the number of negative curvatures;
construct a special charge density gradient path by connecting said one or more minima, maxima, and/or saddle points along a gradient path to a corresponding critical point, wherein each special charge density gradient path represents a path of least steep, steepest or saddle descent that corresponds to an edge of an irreducible bundle;
combine said special charge density gradient paths to construct the irreducible bundle, the irreducible bundle comprising polyhedra formed from a bundle of gradient paths with a common origin and terminus, wherein a vertex of the irreducible bundle is a critical point, an edge of the irreducible bundle is a special gradient path connecting two critical points and a face of the irreducible bundle is a two dimensional ridge and is a minimum area surface of zero flux in the gradient of the charge density that is bounded by special gradient paths;
partition the molecule into non-overlapping unions of irreducible bundles, which are space filling regions, each region containing a single bond point and producing a graphical representation of the union of irreducible bundles to visualize a region of the molecule and associate a region with a property of the molecule, wherein each property of the region represents a property of the bond; and
produce the second molecule with desired properties by applying the information about the property of the first molecule and correlating the property with elements of molecular structure and bonding to design the second molecule.

32. The system of claim 31, wherein said critical point is a bond critical point, a ring critical point, a cage critical point or an atom critical point.

33. The system of claim 31, wherein the maximum and/or minimum is a local maximum and/or minimum.

34. The system of claim 31, wherein the processor is further configured to: combine a set of irreducible bundles sharing the same bond critical point to identify said bond bundle; produce a graphical representation of the bond bundle to visualize a region of the molecule and associate that region with a property of the molecule; and
produce a second molecule with desired properties by applying the information about the property of the first molecule and correlating the property with elements of molecular structure and bonding to design the second molecule.

35. The system of claim 34, wherein the processor is further configured to calculate a property of the molecule.

36. A method of partitioning a first molecule into at least one functional region to determine a property between chemical bonds of the molecule in order to design a second molecule by identifying an irreducible bundle of the first molecule, the method comprising:
finding one or more minima, maxima or saddle points of a charge density associated with the first molecule wherein these points describe the charge density topologically and are defined in terms of an index which is the number of positive curvatures minus the number of negative curvatures;
identifying one or more special charge density gradient paths constituting a one-dimensional ridge that passes through one or more minima, maxima, saddle points of index +1 or saddle points of index −1 of the charge density;
combining the special charge density gradient paths to construct an irreducible bundle, the irreducible bundle comprising polyhedra formed from a bundle of gradient paths with a common origin and terminus, wherein a vertex of the irreducible bundle is a critical point, an edge of the irreducible bundle is a special gradient path connecting two critical points and a face of the irreducible bundle is a two dimensional ridge and is a minimum area surface of zero flux in the gradient of the charge density that is bounded by special gradient paths;
partitioning the molecule into non-overlapping unions of irreducible bundles, which are space filling regions, each region containing a single saddle point of index −1 and producing a graphical representation of the union of irreducible bundles to visualize that region of the molecule and associate that region with a property of the molecule, wherein each property of the region represents a property of the bond; and
producing the second molecule with desired properties by applying the information about the property of the first molecule and correlating the property with elements of molecular structure and bonding to design the second molecule.

37. The method of claim 36, wherein the identifying and finding steps further comprise:
defining constant charge isosurfaces close to the position of each nucleus in said first molecule based on charge density data for the first molecule, the isosurfaces forming one or more closed, nearly spherical, two dimensional surfaces;
determining a magnitude of at least one charge density gradient vector of the charge density data and mapping the magnitude of the vector onto the constant charge isosurface,
identifying one or more minima, maxima, and/or saddle points of said charge density gradient vectors on said isosurface; and
constructing a special charge density gradient path by connecting said one or more minima, maxima, and/or saddle points on said isosurface along a gradient path to a corresponding critical point of the charge density, wherein each special charge density gradient path represents a path of least steep, steepest or saddle descent that corresponds to an edge of an irreducible bundle.

38. The method of claim 37, wherein said critical point of the charge density is a bond critical point, a ring critical point, a cage critical point or an atom critical point with index −1, +1, +3, and −3 respectively.

39. The method of claim 37, wherein the maximum and/or minimum is a local maximum and/or minimum.

40. The method of claim 36, further comprising the steps of
combining a set of irreducible bundles sharing a same bond critical point to identify a bond bundle;
producing a graphical representation of the bond bundle to visualize a region of the molecule and associate that region with a property of the molecule; and
producing the second molecule by applying the information about the property of the first molecule and correlating the property with elements of molecular structure and bonding to design the second molecule.

41. The method of claim 39, further comprising the step of calculating a property of the molecule.
